(19) United States
(12) Patent Application Publication
(10) Pub. No.: US 2025/0125333 A1
(43) Pub. Date: Apr. 17, 2025

(54) BATTERY CONFIGURATION FOR A HYBRID OR ELECTRIC VEHICLE

(71) Applicant: FORD GLOBAL TECHNOLOGIES, LLC, Dearborn, MI (US)

(72) Inventors: Jiyun PARK, Superior Township, MI (US); Chansun PARK, Southfield, MI (US)

(21) Appl. No.: 18/488,289

(22) Filed: Oct. 17, 2023

(51) Int. Cl. H01M 4/13; B60L 50/64; H01M 10/056

(52) U.S. Cl. CPC H01M 4/13; H01M 10/056; B60L 50/64; H01M 2220/20; H01M 2300/0065

(57) ABSTRACT

A battery includes a cathode plate, an anode plate, and an electrolyte. The cathode plate defines a first array of dome-shaped notches. The anode plate defines a second array of dome-shaped notches. The first array of dome-shaped notches is positioned opposite of and facing toward the second array of dome-shaped notches. The electrolyte is disposed between the cathode and anode plates. The electrolyte has dome-shaped protruding regions extending outward therefrom. Each dome-shaped protruding region of a first subset of the dome-shaped protruding regions extends into and contacts the cathode within one of the dome-shaped notches of the first array of dome-shaped notches. Each dome-shaped protruding region of a second subset of the dome-shaped protruding regions extends into and contacts the anode within one of the dome-shaped notches of the second array of dome-shaped notches.

### TECHNICAL FIELD

The present disclosure relates to hybrid/electric vehicles and batteries for hybrid/electric vehicles.

### BACKGROUND

Hybrid/electric vehicles may be propelled by an electric machine that draws power from a battery.

### SUMMARY

A battery includes a cathode plate, an anode plate, and an electrolyte. The cathode plate defines a first array of dome-shaped notches. The anode plate defines a second array of dome-shaped notches. The first array of dome-shaped notches is positioned opposite of and facing toward the second array of dome-shaped notches. The electrolyte is disposed between the cathode and anode plates. The electrolyte has dome-shaped protruding regions extending outward therefrom. Each dome-shaped protruding region of a first subset of the dome-shaped protruding regions extends into and contacts the cathode within one of the dome-shaped notches of the first array of dome-shaped notches. Each dome-shaped protruding region of a second subset of the dome-shaped protruding regions extends into and contacts the anode within one of the dome-shaped notches of the second array of dome-shaped notches.

A battery includes a cathode, an anode, and an electrolyte. The cathode defines a first set of notches. The anode defines a second set of notches. The notches of the first and second sets of notches are partially ellipsoid-shaped. The first set of notches are positioned opposite of and facing toward the second set of notches. The electrolyte is disposed between the cathode and anode. The electrolyte has protruding regions extending outward from first and second opposing surfaces. Each of the protruding regions extending from the first opposing surface further extends into and contacts the cathode within one of the notches of the first set of notches. Each of the protruding regions extending from the second opposing surface further extends into and contacts the anode within one of the notches of the second set of notches.

A battery includes a positive electrode, a negative electrode, and a solid-state electrolyte. The positive electrode defines a first set of notches. The negative electrode defines a second set of notches. The first set of notches are positioned opposite of and facing toward the second set of notches. The solid-state electrolyte is disposed between the positive and negative electrodes. The solid-state electrolyte has rounded protruding regions extending outward from first and second surfaces. Each rounded protruding region extending from the first surface further extends into one of the notches of the first set of notches. Each protruding region extending from the second surface further extends into one of the notches of the second set of notches.

### BRIEF DESCRIPTION OF THE DRAWINGS

FIG. 1 is a schematic illustration of a representative powertrain of an electric vehicle;

FIG. 2 is a schematic illustration of a solid-state battery;

FIG. 3 includes contour plots depicting the hydrostatic pressure distribution of the solid-state battery relative to a solid-state battery having a traditional design;

FIG. 4 includes contour plots depicting the principal stress distribution of the solid-state battery relative to the solid-state battery having a traditional design;

FIG. 5 includes contour plots depicting the electrode current density distribution of the solid-state battery relative to the solid-state battery having a traditional design at the onset of a constant current charge; and

FIG. 6 includes contour plots depicting the electrode current density distribution of the solid-state battery relative to the solid-state battery having a traditional design at a 50% state of lithiation in cathode during the constant current charge.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

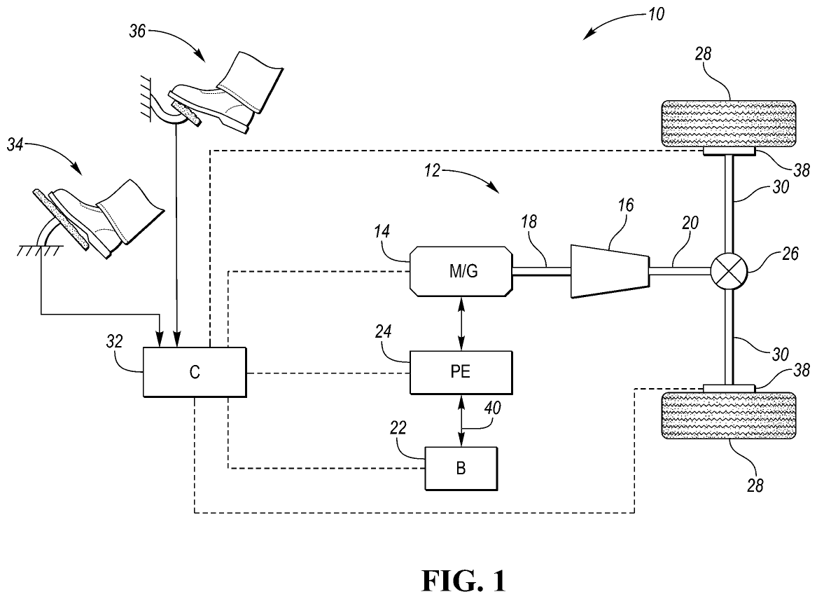

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an electric motor/generator (M/G) 14 that drives a transmission (or gearbox) 16. More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated traction battery 22 is configured to deliver electrical power to or receive electrical power from the M/G 14.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 20 and the transmission input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of drive wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the powertrain control unit 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16. Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission gearbox 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, speed decrease or shift mode (MDE), battery temperature, voltage, current, or state of charge (SOC) for example.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for case of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12. To drive the vehicle with the M/G 14 the traction battery 22 transmits stored electrical energy through wiring 40 to the power electronics 24 that may include inverter and rectifier circuitry, for example. The inverter circuitry of the power electronics 24 may convert DC voltage from the battery 22 into AC voltage to be used by the M/G 14. The rectifier circuitry of the power electronics 24 may convert AC voltage from the M/G 14 into DC voltage to be stored with the battery 22. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It should be understood that the vehicle configuration described herein is merely exemplary and is not intended to be limited. Other electric or hybrid electric vehicle configurations should be construed as disclosed herein. Other electric or hybrid vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art.

In hybrid configurations that include an internal combustion engine such as a gasoline, diesel, or natural gas powered engine, or a fuel cell, the controller 32 may be configured to control various parameters of such an internal combustion engine. Representative examples of internal combustion parameters, systems, and/or components that may be directly or indirectly actuated using control logic and/or algorithms executed by the controller 32 include fuel injection timing, rate, and duration, throttle valve position, spark plug ignition timing (for spark-ignition engines), intake/exhaust valve timing and duration, etc. Sensors communicating input through the I/O interface from such an internal combustion engine to the controller 32 may be used to indicate turbocharger boost pressure, crankshaft position (PIP), engine rotational speed (RPM), intake manifold pressure (MAP), throttle valve position (TP), exhaust gas oxygen (EGO) or other exhaust gas component concentration or presence, intake air flow (MAF), etc.

It should be understood that the schematic illustrated in FIG. 1 is merely representative and is not intended to be limiting. Other configurations are contemplated without deviating from the scope of the disclosure. For example, the vehicle powertrain 12 may be configured to deliver power and torque to the one or both of the front wheels as opposed to the illustrated rear wheels 28.

Solid-state batteries (SSBs) have been considered as an alternative for electric and hybrid vehicles because they employ solid electrolytes which are relatively stable. However, SSBs typically have a limitation in charging rate due to a slower diffusion of Lithium (Li) ions in solid electrolytes when compared to liquid electrolytes.

Previous approaches in utilizing SSBs have been limited to patterned electrodes (i.e., cathodes and anodes), which have three-dimensional rectangular shape grooves with sharp edges. Although such approaches could enable fast charging by reducing the Li ion diffusion pathway when compared to flat interfaces, mechanical stability of the structure may be limited, and potential Li plating could occur. Li plating could result in interfacial issues, short circuit, and/or thermal runaway. First, high pressure, usually over 100 MPa, is applied to the individual SSB components and the entire cell in the processes of manufacturing, which may include calendering, laminating, and cell assembly to densify solid electrode in order to achieve better contact to enhance ionic conductivity between multiple solid components. Also, SSBs often operates under stack pressure to ensure interfacial contact between two different solids components. Even if the stack pressure is smaller than the pressure during manufacturing, the stack pressure during repeated cycles could affect the mechanical stability and cell performance over a period of time. Hence, the patterned structure should be mechanically strong enough to endure the high pressure and to maintain its structure. Second, the uniform current density distribution is disturbed by the patterns. In addition to the original patterned structure, if the fractures under high pressure during manufacturing, numerous sharp edges could be additionally formed at the interface. The current density would be localized at every edge of the rectangular patterns as well as that of the potential fractures. The localized current density would provoke localized Li plating, causing issues. In conclusion, a mechanically stable patterned structure in SSBs should be developed to achieve both fast charging capability and increased stability.

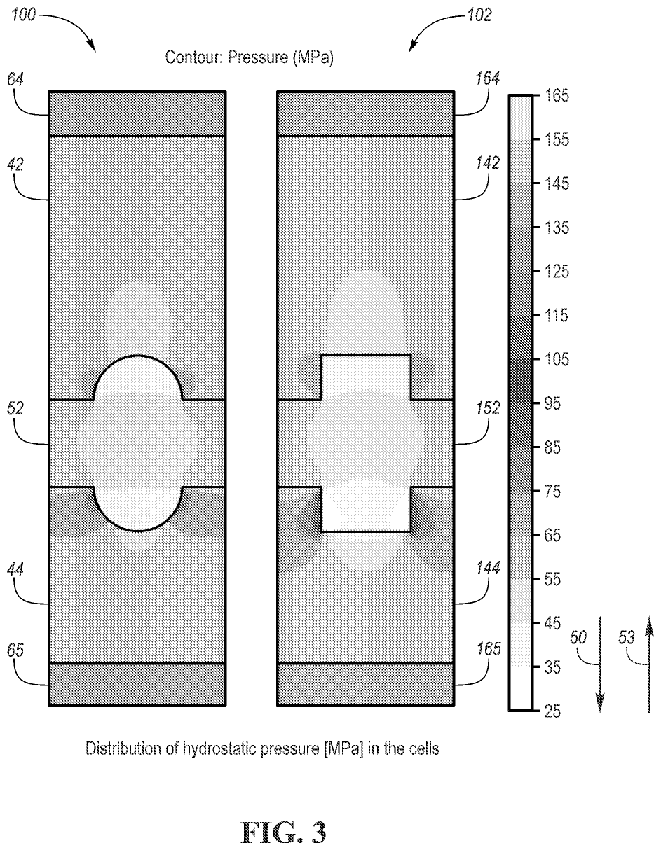

A three-dimensional dome-like patterned electrode for SSBs which would show both better mechanical strength and the capability for fast charging compared to the typical rectangular patterns. First, such a design has mechanically stable interfaces, which is critical during SSB manufacturing processes under high pressure. For example, such a design would dissipate applied pressures during SSB manufacturing processes, eliminating mechanical issues in the structure and eliminating the creation of sharp edges cause by mechanical issues. Furthermore, such a design enables fast charging by utilizing a larger interfacial area and fast charge/ion transfer without localized high current density. The current density distribution in such as design would be more uniform without significant localization of current density that has been known as a root cause of Li plating. Such a design was investigated using physics-based modeling, and was compared to a rectangular shaped pattern to demonstrate better mechanical strength and more uniform current density distribution (see FIGS. 3-6).

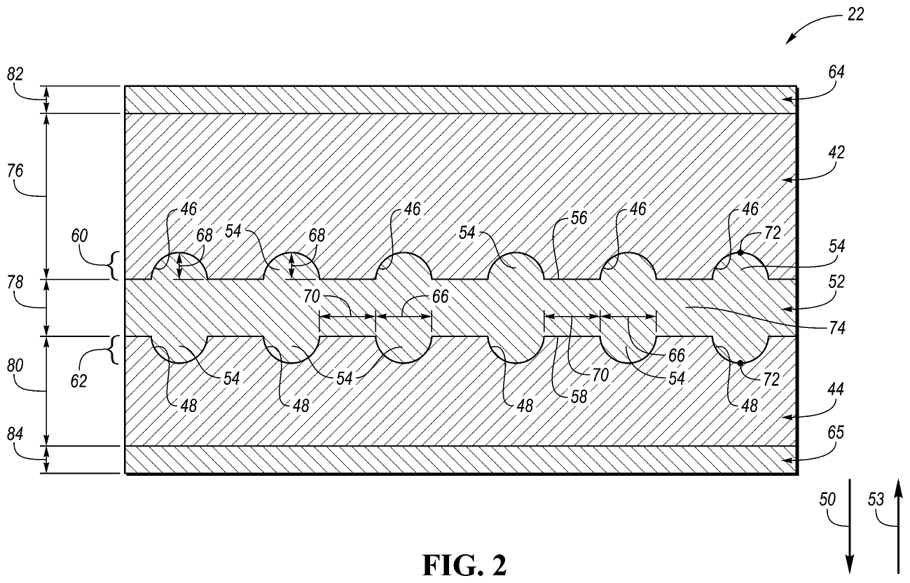

Referring to FIG. 2, the battery 22 is illustrated in further detail. The battery 22 includes a cathode 42 and an anode 44. The cathode 42 and anode 44 may be each be formed as plates. The cathode 42 may refer to a negatively charged electrode while the anode 44 may refer to a positively charged electrode. The cathode 42 defines a first array or a first set of notches 46. The anode 44 defines a second array or a second set of notches 48. The notches from each of the first set of notches 46 and the second set of notches 48 may be rounded, dome-shaped, or partially ellipsoid-shaped. More specifically, the partial ellipsoid-shape of the first set of notches 46 and the second set of notches 48 may appear as partial ellipses (e.g., half-ellipses) when viewed from a side of the battery 22 (e.g., as illustrated in FIG. 2) and may appear as whole ellipses or circles when viewed from a top or bottom of the battery 22 (e.g., when viewed along direction 50 or direction 53 as illustrated in FIG. 2).

The first set of notches 46 are positioned opposite of and facing toward the second set of notches 48. An electrolyte 52 is disposed between the cathode 42 and the anode 44. The electrolyte 52 may be a solid-state electrolyte. The electrolyte 52 has protruding regions 54 extending outward from first and second opposing surfaces 56, 58 of the electrolyte 52. The protruding regions 54 may also be rounded, dome-shaped, or partially ellipsoid-shaped.

Each protruding region 54 within a first subset of the protruding regions 60 extends into and contacts the cathode 42 within one of the notches of first set of notches 46. The first subset of the protruding regions 60 may more specifically refer to a set of the protruding regions 54 that extends from the first surface 56 of the electrolyte 52. More specifically, each notch within the first set of notches 46 may be completely filled or occupied by one of the protruding regions 54 of the of the first subset of the protruding regions 60. Stated in other terms, each protruding region 54 within the first subset of the protruding regions 60 occupies an entirety of a corresponding notch (e.g., one of notches within the first set of notches 46).

Each protruding region 54 within a second subset of the protruding regions 62 extends into and contacts the anode 44 within one of the notches of second set of notches 48. The second subset of the protruding regions 62 may more specifically refer to a set of the protruding regions 54 that extends from the second surface 58 of the electrolyte 52. More specifically, each notch within the second set of notches 48 may be completely filled or occupied by one of the protruding regions 54 of the second subset of the protruding regions 62. Stated in other terms, each protruding region 54 within the second subset of the protruding regions 62 occupies an entirety of a corresponding notch (e.g., one of notches within the second set of notches 48).

The first set of notches 46, second set of notches 48, and the protruding regions 54 are illustrated as being arranged in a one-dimensional array that extends from left to right in FIG. 2. However, it should be understood that the first set of notches 46, second set of notches 48, and the protruding regions 54 may be arranged in a two-dimensional array that extends from left to right in FIG. 2 and into the image of FIG. 2. Furthermore, the number of notches in the first set of notches 46, the number of notches in the second set of notches 48, and number of protruding regions 54 in FIG. 2 is for illustrative purposes only. The first set of notches 46, second set of notches 48, and protruding regions 54 may include any number of notches and protruding regions that are arranged in an array.

The battery 22 further includes a cathode current collector 64 that is disposed on an opposing side of the cathode 42 relative to the electrolyte 52 and an anode current collector 65 that is disposed on an opposing side of the anode 44 relative to the electrolyte 52.

Each protruding region 54 and each notch (e.g., the notches within the first set of notches 46 and/or second set of notches 48) has a first dimension 66 (e.g., a width) and a second dimension 68 (e.g., a height). A ratio of the first dimension 66 to the second dimension 68 may range between 1 and 10. Each protruding region 54 and each notch (e.g., the notches within the first set of notches 46 and/or second set of notches 48) are spaced-apart from each other by a third dimension 70 (e.g., a spatial distance). A ratio of the first dimension 66 to the third dimension 70 may range between 0.1 and 10. Each protruding region 54 of the first subset of protruding regions 60 forms an aligned pair with one of the protruding regions 54 of the second subset of protruding regions 62. More specifically, the apexes 72 of the protruding regions 54 within each aligned pair may be aligned along direction 50, direction 53, or vertically.

The protruding regions 54 within each aligned pair extend outward from central a region 74 of the electrolyte 52 in opposing directions (e.g., the first and second directions 50, 53). The cathode 42 has a fourth dimension 76 (e.g., a height), the central region 74 has a fifth dimension 78 (e.g., a height). A ratio of the fourth dimension 76 to the fifth dimension 78 may range between 1 and 20. The anode 44 has a sixth dimension 80 (e.g., a height). A ratio of the sixth dimension 80 to the fifth dimension 78 may range between 1 and 20. The cathode current collector 64 has a seventh dimension 82 (e.g., a height). A ratio of the fourth dimension 76 to the seventh dimension 82 may range between 0.1 and 20. The anode current collector 65 has an eighth dimension 84 (e.g., a height). A ratio of the eighth dimension 84 to the sixth dimension 80 may range between 0.1 and 20.

The dome-like structure of a single “cell” or section 100 of the solid-state battery design (e.g., battery 22) described herein was investigated using physics-based modeling. The section 100 includes at least portions of the cathode 42, anode 44, solid-state electrolyte 52, cathode current collector 64, and the anode current collector 65. The design was compared to a single “cell” or section 102 of a solid-state battery having a rectangular shaped pattern to demonstrate an increase in mechanical strength and a more uniform current density distribution. Section 102 of a solid-state battery includes at least portions of a cathode 142, an anode 144, a solid-state electrolyte 152, a cathode current collector 164, and an anode current collector 165

Physics-based modeling was performed using COMSOL 6.1 for thin-film type SSBs. A periodic boundary condition was applied to reduce computational expense. For stress analysis, 100 MPa of pressure was applied to the anode current collector in the normal direction (e.g., direction 50 or direction 53). Deformation of the cell structure, pressure distribution, and the first principal stress were analyzed. For current density distribution analysis, a constant current constant voltage (CC-CV) charge with 1C of C-rate was applied and the current density distribution was analyzed at the onset of charging and at 50% of state of lithiation of cathode.

FIG. 3 illustrates contour plots depicting the hydrostatic pressure distribution in different regions of the cells 100, 102. The pressure is more evenly distributed in the dome-like pattern (i.e., cell 100). Specifically, the maximum and minimum applied pressure are 98 MPa and 36 MPa, respectively, in the dome-like design (i.e., cell 100) whereas they are 154 MPa and 27 MPa in the conventional design (i.e., cell 102). The maximum pressure is smaller by ˜36% and the variation in pressure is ˜51% smaller in the dome-like design compared to the conventional design. Also, the change in hydrostatic pressure at the two vertices of the rectangular pattern is abrupt (by ˜80 MPa), which is likely to cause mechanical issues. In comparison, there is no such a significant pressure change in the new design, indicating mechanically stable interface under high pressure.

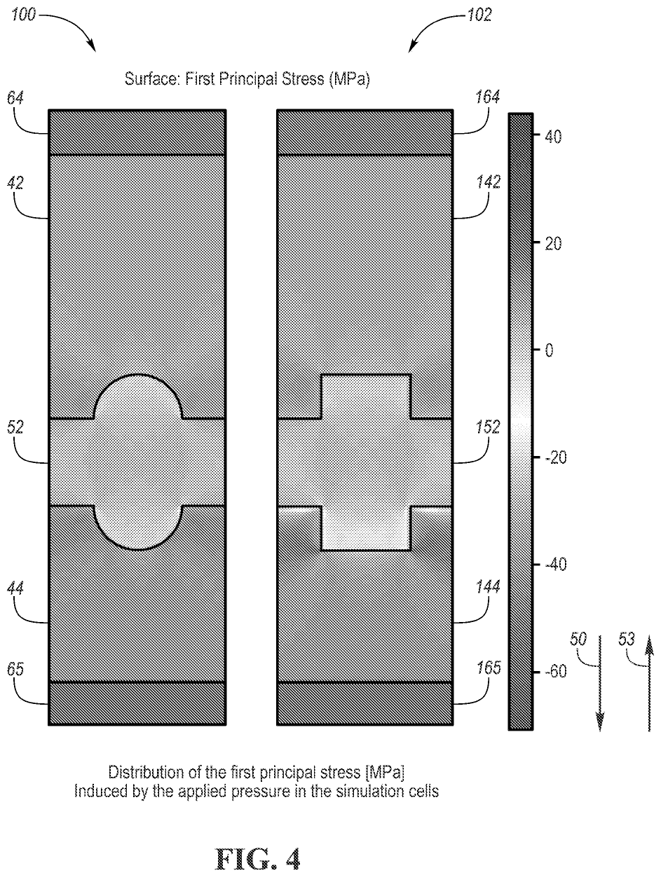

FIG. 4 illustrates the first principal stress distribution in different regions of the cells 100, 102. The first principal stress was used as a metric to identify the location of possible mechanical issues. The maximum compressive and tensile first principal stresses in the new design (i.e., cell 100) are ˜16 MPa and ˜54 MPa whereas they are ˜45 MPa and ˜71 MPa in the conventional design (i.e., cell 102). The variation in the first principal stress is about 40% smaller in the dome-like design (i.e., cell 100) compared to the conventional design (i.e., cell 102). In the new dome-like design (i.e., cell 100), no significant variation in the first principal stress is observed while the edges of the conventional design (i.e., cell 102) are under large tensile and compressive stresses. Thus, mechanical issues may be generated at the interface in the conventional design (i.e., cell 102). With some changes in the mechanical structure of the conventional design (i.e., cell 102) resulting from the stresses, the SSB amy still operate if there are available ion pathways. However, the changes in the mechanical structure may result in higher impedance, leading to a decrease in battery performance. Thus, the dome-like structure is more mechanically reliable by dissipating the first principal stresses.

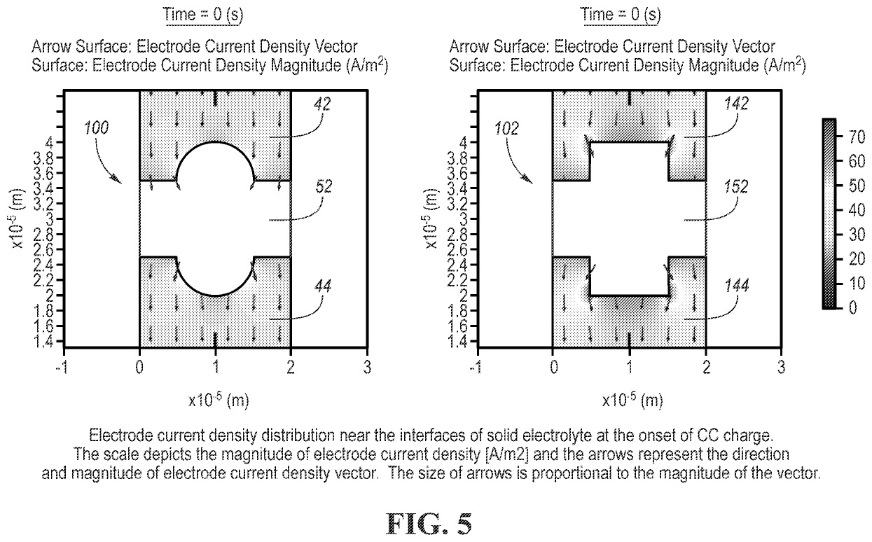

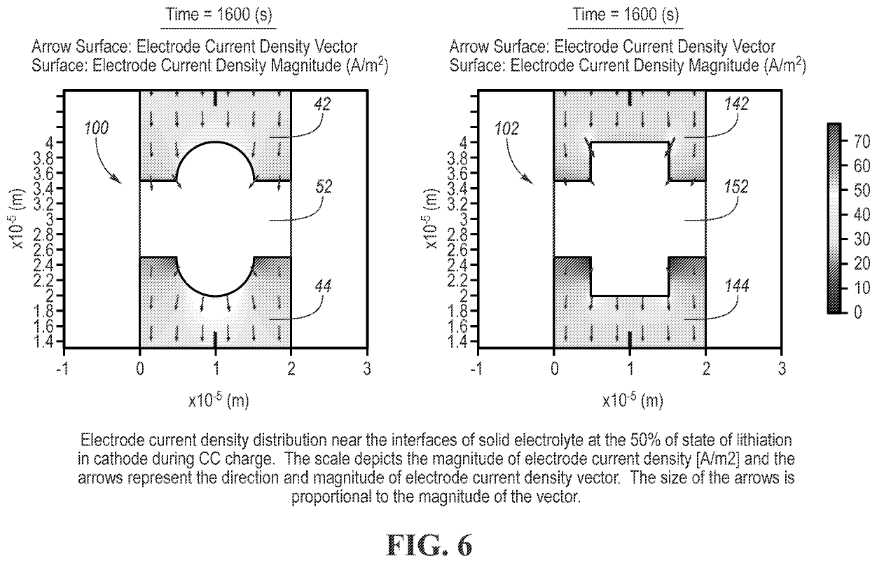

FIG. 5 and FIG. 6 illustrate the electrode current density distribution near the interface between solid electrolyte and the patterned electrodes in the dome-like design (i.e., cell 100) when compared to the conventional design (i.e., cell 102). The scale depicts the magnitude of electrode current density [A/m²] and the arrows represent the direction and magnitude of electrode current density vector. The size of arrows is proportional to the magnitude of the vector. At the onset of CC charge, depicted in FIG. 5, the maximum and minimum current density are 50 A/m² and 26 A/m², respectively, in the dome-like design (i.e., cell 100), whereas the maximum and minimum current density are 78 A/m² and 22 A/m², respectively, in the conventional design (i.e., cell 102). The maximum current density is ˜36% smaller and the variation is smaller by ˜57% in the dome-like design (i.e., cell 100) compared to the conventional design (i.e., cell 102).

At the 50% of state of lithiation in cathode during CC charge, depicted in FIG. 6, the maximum and minimum current density are 51 A/m² and 10 A/m², respectively, in the dome-like design (i.e., cell 100) whereas the maximum and minimum current density are 62 A/m² and 7 A/m², respectively, in the conventional design (i.e., cell 102). The maximum current density is still ˜18% smaller and the variation is smaller by ˜25% in the dome-like design (i.e., cell 100) compared to the conventional design (i.e., cell 102). In both states of charge (i.e., at the onset of CC charge and at the 50% of state of lithiation in cathode during CC charge), the current density is more uniformly distributed in the dome-like design (i.e., cell 100) as illustrated by the smaller variation relative to the conventional design (i.e., cell 102). The conventional design (i.e., cell 102) shows localized current density at the edges of sharp edges, which would result in Li plating and eventually cell degradation. The dome-like structure (i.e., cell 100) eliminates the localized current density, which reduces or eliminates Li plating.

The dome-like pattern (i.e., cell 100) has mechanically stable interfaces, which is critical during SSB manufacturing processes under high pressure. The pattern dissipates and distributes the applied pressure evenly. The dome-like pattern (i.e., cell 100) also enables fast charging by utilizing the larger interfacial area and fast charge/ion transfer without localized high current density. The highly localized current density has been known as a root cause of Li plating.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A battery comprising:
a cathode plate defining a first array of dome-shaped notches;
an anode plate defining a second array of dome-shaped notches, wherein the first array of dome-shaped notches is positioned opposite of and facing toward the second array of dome-shaped notches; and
an electrolyte (i) disposed between the cathode and anode plates and (ii) having dome-shaped protruding regions extending outward therefrom, wherein (a) each dome-shaped protruding region of a first subset of the dome-shaped protruding regions extends into and contacts the cathode within one of the dome-shaped notches of the first array of dome-shaped notches and (b) each dome-shaped protruding region of a second subset of the dome-shaped protruding regions extends into and contacts the anode within one of the dome-shaped notches of the second array of dome-shaped notches.

2. The battery of claim 1, wherein the electrolyte is a solid-state electrolyte.

3. The battery of claim 1, wherein (i) each dome-shaped protruding region has a width and a height and (ii) a ratio of the width to the height ranges between 1 and 10.

4. The battery of claim 1, wherein (i) each of the dome-shaped protruding regions has a width, (ii) adjacent dome-shaped protruding regions are spaced-apart from each other by a distance, and (iii) a ratio of the width to the distance ranges between 0.1 and 10.

5. The battery of claim 1, wherein each of the dome-shaped protruding regions occupies an entirety of a corresponding dome-shaped notch.

6. The battery of claim 1, wherein (i) each of the dome-shaped protruding regions of the first subset of dome-shaped protruding regions forms an aligned pair with one of the dome-shaped protruding regions of the second subset of dome-shaped protruding regions and (ii) the dome-shaped protruding regions within each pair extend outward from central region of the electrolyte in opposing directions.

7. The battery of claim 6, wherein (i) the cathode has a first height, (ii) the central region has a second height, and (iii) a ratio of the first height to the second height ranges between 1 and 20.

8. The battery of claim 6, wherein (i) the anode has a first height, (ii) the central region has a second height, and (iii) a ratio of the first height to the second height ranges between 1 and 20.

9. A battery comprising:
a cathode defining a first set of notches;
an anode defining a second set of notches, wherein (i) the notches of the first and second sets of notches are partially ellipsoid-shaped and (ii) the first set of notches are positioned opposite of and facing toward the second set of notches; and
an electrolyte (i) disposed between the cathode and anode and (ii) having protruding regions extending outward from first and second opposing surfaces, wherein (a) each of the protruding regions extending from the first opposing surface further extends into and contacts the cathode within one of the notches of the first set of notches and (b) each of the protruding regions extending from the second opposing surface further extends into and contacts the anode within one of the notches of the second set of notches.

10. The battery of claim 9, wherein the electrolyte is a solid-state electrolyte.

11. The battery of claim 9, wherein (i) each notch of the first and second sets of notches has a width and a height and (ii) a ratio of the width to the height ranges between 1 and 10.

12. The battery of claim 9, wherein (i) each notch of the first and second sets of notches has a width, (ii) adjacent notches within the first and second sets of notches are spaced-apart from each other by a distance, and (iii) a ratio of the width to the distance ranges between 0.1 and 10.

13. The battery of claim 9, wherein each of the protruding regions occupies an entirety of a corresponding notch.

14. The battery of claim 9, wherein (i) each of the protruding regions extending from the first opposing surface forms an aligned pair with one of the protruding regions extending from the second opposing surface and (ii) the protruding regions within each pair extend outward from central region of the electrolyte in opposing directions.

15. The battery of claim 14, wherein (i) the cathode has a first height, (ii) the central region has a second height, and (iii) a ratio of the first height to the second height ranges between 1 and 20.

16. The battery of claim 14, wherein (i) the anode has a first height, (ii) the central region has a second height, and (iii) a ratio of the first height to the second height ranges between 1 and 20.

17. A battery comprising:
a positive electrode defining a first set of notches;
a negative electrode defining a second set of notches facing toward the first set of notches; and
a solid-state electrolyte, disposed between the positive and negative electrodes, defining rounded protruding regions extending outward from first and second surfaces and into the first and second sets of notches.

18. The battery of claim 17, wherein each of the notches of the first and second sets of notches has a width and a height and a ratio of the width to the height ranges between 1 and 10.

19. The battery of claim 17, wherein each of the notches of the first and second sets of notches has a width, adjacent notches within the first and second sets of notches are spaced-apart from each other by a distance, and a ratio of the width to the distance ranges between 0.1 and 10.

20. The battery of claim 17, wherein each of the protruding regions extending from the first surface forms an aligned pair with one of the protruding regions extending from the second surface, and the protruding regions within each pair extend outward from central region of the electrolyte in opposing directions.
